(19) United States
(12) Patent Application Publication
(10) Pub. No.: US 2022/0378195 A1
(43) Pub. Date: Dec. 1, 2022

(54) COMBINED TYPE SHELF

(71) Applicant: Protrend Co., Ltd., Taipei City (TW)

(72) Inventor: SHUN-YI CHEN, Taipei City (TW)

(21) Appl. No.: 17/399,096

(22) Filed: Aug. 11, 2021

(30) Foreign Application Priority Data
May 28, 2021 (TW) 110119383

(51) Int. Cl. A47B 57/34; A47B 88/407

(52) U.S. Cl. CPC A47B 57/34; A47B 88/407

(57) ABSTRACT

A combined type shelf includes column assemblies, first horizontal constraint assemblies, second horizontal constraint assemblies and storage layers. The column assembly includes assembly holes. The first horizontal constraint assembly has a first horizontal-constraint connecting fastener including horizontal-constraint hanging structures and rivets. The horizontal-constraint hanging structure engages the assembly hole to connect the first horizontal constraint assembly to a front or rear side of the column assembly. The second horizontal constraint assembly includes a horizontal-constraint hole to engage the rivet so as to connect the second horizontal constraint assembly to a left-hand or right-hand side of the column assembly. In addition, the storage layers are disposed between these column assemblies.

### CROSS REFERENCE TO RELATED APPLICATION

This application claims the benefits of Taiwan application Serial No. 110119383, filed on May 28, 2021, the disclosures of which are incorporated by references herein in its entirety.

### TECHNICAL FIELD

The present disclosure relates in general to a shelf structure, and more particularly to a combined type shelf structure.

### BACKGROUND

Modular furniture becomes more and more popular due to its convenience in transportation and storage, and thus it can be widely seen in domestic, office or workplace application. Some modular furniture, such as a combined type shelf, can be randomly combined into different formulations to meet various needs in size or shape.

Traditionally, a typical combined type shelf is formed by fixing firmly pipes or racks by screws, bolts, etc. Particularly, such a combined type shelf is usually formed by two parallel-rod side frames and several parallel storage layers horizontally mounted between the two standing parallel-rod side frames. This parallel-rod side frame includes two vertical poles separated by a predetermined distance and at least two horizontal iron wires arranged between the two vertical poles by welding or some other fixation means. Each of the storage layers can be fixed to the horizontal iron wires by iron plate hooks on a wooden board of the storage layer, and plural crossing traction wire structures are appropriately applied to fix the entire shelf as a whole at rear sides of the two parallel-rod side frames and the storage layers. While in assembling this type of shelve, hand tools are necessary, and thus assembly and application inconvenience is inevitable.

Therefore, how to improve the aforesaid problems encountered in the art is definitely one of the issues to be solved by this industry.

### SUMMARY

An object of the present disclosure is to provide a combined type shelf whose assembly work can be easily finished without any locking part or tool. The combined type shelf is simply and stably structured to provide superior assembly flexibility assembly.

In this disclosure, one embodiment of the combined type shelf includes at least two column assemblies, a plurality of first horizontal constraint assemblies, a plurality of second horizontal constraint assemblies and a plurality of storage layers. Each of the at least two column assemblies includes a plurality of assembly holes. Each of the plurality of first horizontal constraint assemblies includes a first horizontal constraint member and two first horizontal-constraint connecting fasteners/The two first horizontal-constraint connecting fasteners are connected respectively to two opposite ends of the first horizontal constraint member, in which each of the two first horizontal-constraint connecting fasteners includes at least one horizontal-constraint hanging structure and at least one rivet. Each of the at least one horizontal-constraint hanging structure is lowered in an assembly direction to engage one of the plurality of assembly holes to connect the corresponding first horizontal constraint assembly to a font side or a rear side of the respective column assembly. Each of the plurality of second horizontal constraint assemblies includes at least one horizontal-constraint hole, and each of the at least one horizontal-constraint hole is lowered in the assembly direction to engage one of the at least one rivet to connect the corresponding second horizontal constraint assembly to a left-hand side or a right-hand side of the respective column assembly. The plurality of storage layers are disposed between two of the at least two column assemblies, each of the plurality of first horizontal constraint assemblies and each of the plurality of second horizontal constraint assemblies are used to support one of the plurality of storage layers.

In one embodiment, the combined type shelf further includes a plurality of engagement portions, each of the plurality of engagement portions connects the first horizontal constraint member, and each of the plurality of engagement portions includes a hanging slot.

In one embodiment, the combined type shelf further includes an accessory frame. The accessory flame includes a plurality of hanging protrusions, and each of the plurality of hanging protrusions is engaged with the corresponding hanging slot of the respective engagement portion.

In one embodiment, the combined type shelf further includes a plurality of positioning gaps disposed at the first horizontal constraint member. Each of the plurality of positioning gaps is used for holding and positioning at least one partition plate on the storage layer.

In one embodiment, the plurality of partition plates form one of a drawer unit, a swing-door cabinet and a cube storage unit.

In one embodiment, each of the horizontal-constraint holes is extended in the assembly direction by having an initial bigger hole and a narrower end slot.

In one embodiment, each of the column assemblies includes a first upright pillar and a second upright pillar, at least one surface of the first upright pillar is furnished orderly with the assembly holes, at least another one surface of the second upright pillar is furnished orderly with the assembly holes, and each of the assembly holes on the first upright pillar and the second upright pillar is extended in the assembly direction into an inverted trapezoid shape.

As stated, the combined type shelf provided in this disclosure needs no tools for assembly. With the assembly holes of the column assembly, the first horizontal constraint assembly and the second horizontal constraint assembly can be easily mounted to form the combined type shelf of this disclosure, the horizontal extension of the combined type shelf is then much easier, and also the entire assembly flexibility can be kept high.

In addition, since the first horizontal constraint assembly of this disclosure is provided with the hanging function, thus the accessory frame can be arbitrarily added into the combined type shelf, and so the entire flexibility can be further upraised.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the combined type shelf in accordance with this disclosure;

FIG. 2A is a schematic exploded view of the first upright pillar of FIG. 1;

FIG. 2B is a further sectional enlarged view of FIG. 2A;

FIG. 3A is a schematic exploded view of the first horizontal constraint assembly of FIG. 1;

FIG. 3B is a schematic enlarged view of the first horizontal-constraint connecting fastener of FIG. 3A;

FIG. 3C is anther view of FIG. 3B;

FIG. 4A is a schematic exploded view of the second horizontal constraint assembly of FIG. 1;

FIG. 4B is a schematic enlarged view of the second horizontal-constraint connecting fastener of FIG. 4A;

FIG. 5A demonstrates schematically an assembly process of the first horizontal constraint assemblies and the upright pillars of the combined type shelf of FIG. 1;

FIG. 5B is an enlarged view of area A1 of FIG. 5A;

FIG. 5C and FIG. 5D show schematically two consecutive stages of the assembly process of FIG. 5A in the assembly direction, in which the horizontal-constraint hanging structures of the first horizontal constraint assembly engage the corresponding assembly holes on the upright pillar of the combined type shelf;

FIG. 6A shows schematically that the combination of FIG. 5A is further assembled with two second horizontal constraint assemblies;

FIG. 6B and FIG. 6C show schematically two consecutive stages of an assembly process of FIG. 6A in the assembly direction, in which the horizontal-constraint holes of the second horizontal constraint assembly engage the corresponding rivets on the first horizontal-constraint connecting fastener of the combined type shelf;

FIG. 7A demonstrates schematically an exemplary example of FIG. 6A furnished with an accessory frame connecting the two first horizontal constraint assemblies;

FIG. 7B is an enlarged view of area A2 of FIG. 7A;

FIG. 8A demonstrates schematically another assembly process of the combined type shelf to provide a horizontal extension;

FIG. 8B is an enlarged view of area A3 of FIG. 8A;

FIG. 9A and FIG. 9B show schematically two consecutive stages of a further assembly process upon FIG. 8A, in which the second horizontal constraint assembly is assembled to the structure of FIG. 8B;

FIG. 10A shows schematically the assembly of partition plates to the combined type shelf of FIG. 1;

FIG. 10B is an enlarged view of area A4 of FIG. 10A; and

FIG. 10C is an enlarged view of area A5 of FIG. 10A.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

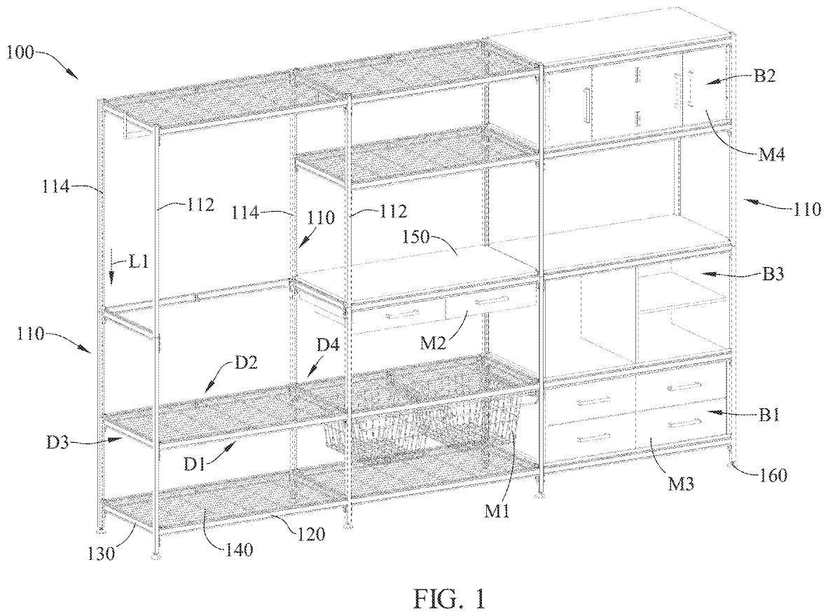

FIG. 1 is a schematic view of an embodiment of the combined type shelf in accordance with this disclosure. As shown, in this embodiment, the combined type shelf 100 includes at least two column assemblies 110, a plurality of first horizontal constraint assemblies 120, a plurality of second horizontal constraint assemblies 130, a plurality of storage layers including at least a first storage layer 140 and a second storage layer 150, and a plurality of foot stands 160. In the combined type shelf 100 of FIG. 1, the first storage layer 140 and the second storage layer 150 are disposed fixedly between the two lateral column assemblies 110. Each of the first horizontal constraint assemblies 120 or the second horizontal constraint assembly 130 is used to support the corresponding storage layer such as the first storage layer 140 or the second storage layer 150. In this embodiment, the first storage layer 140 is a wire storage layer, and the second storage layer 150 is a plate storage layer. That is, the structuring of the combined type shelf 100 according to this disclosure is to provide a base structure for mounting different layer structures. By providing the first horizontal constraint assemblies 120 and the second horizontal constraint assemblies 130, assembling of the combined type shelf 100 can be carried on without any assembly tools. In addition, the first horizontal constraint assemblies 120 are adopted to keep those column assemblies 110 parallel to each other, as shown in FIG. 1. In this embodiment, four column assemblies 110 are raised vertically and in parallel to each other, so that three accommodation spaces in this combined type shelf 100 can be provided to mount various storage structures such as the aforesaid storage layers. In this embodiment, quantities of the first storage layers 140, the second storage layers 150, the first horizontal constraint assemblies 120 and the second horizontal constraint assemblies 130 are adjustable to meet practical requirements. Also, in this embodiment, the foot stands 160 are provided under the corresponding column assemblies 110 so as to enhance the entire stability of the combined type shelf 100. In the following description, detail structures of the column assembly 110, the first horizontal constraint assembly 120 and the second horizontal constraint assembly 130 will be elucidated orderly.

In this embodiment, as shown in FIG. 1, the combined type shelf 100 has four column assemblies 110, and each of the column assemblies 110 includes a first upright pillar 112 and a second upright pillar 114. It shall be explained that, practically, dispositions and types of the first upright pillar 112 and the second upright pillar 114 are the same. However, for concise explanation, they are assigned with different names and signs. Here, it is defined that the two first upright pillars 112 of the two respective neighboring column assemblies 110 are individually disposed at a front side D1 of the combined type shelf 100, but spaced to each other by a distance; and, the two second upright pillars 114 of the two respective neighboring column assemblies 110 are individually disposed at a rear side D2 of the combined type shelf 100, but spaced to each other also by a distance. Further, at the right-hand side D3 or the left-hand side D4 of the combined type shelf 100, the first upright pillar 112 and the corresponding second upright pillar 114 are spaced by a distance. As shown in FIG. 1, the front side D1, the rear side D2, the right-hand side D3 and the left-hand side D4 are referred to the relative positions formed in correspondence with the two parallel column assemblies 110.

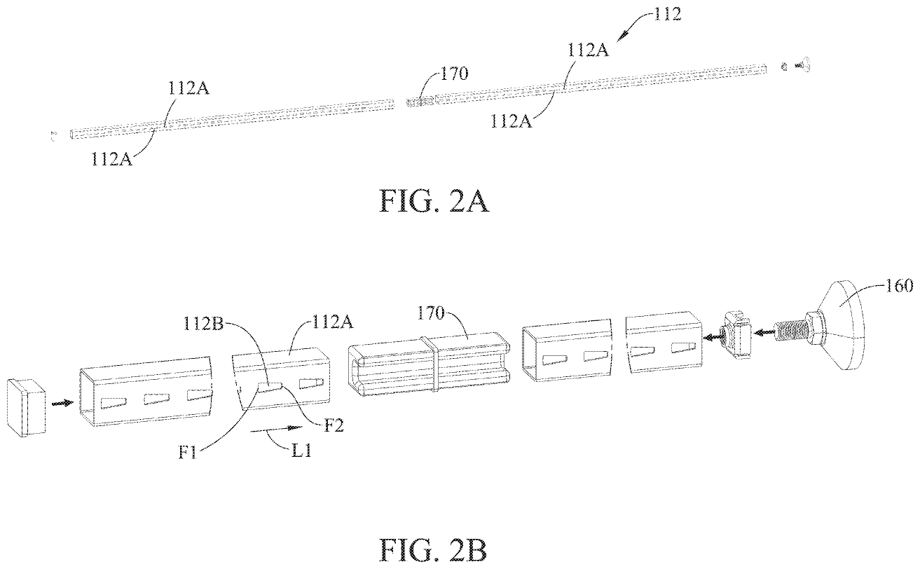

In this embodiment, referring to FIG. 2A and FIG. 2B, the first upright pillar 112 includes a tubular column body 112A and a plurality of assembly holes 112B. The tubular column body 112A itself is a hollow square pipe structure. In one embodiment, two tubular column bodies 112A can be connected linearly via a dual-end plug connector 170. Thereupon, the total length of the first upright pillar 112 can be extended. Similarly, the second upright pillar 114 can be lengthily extended via the dual-end plug connectors 170.

In this embodiment, the plurality of assembly holes 112B can be orderly lined up on one surface of the tubular column body 112A of the first upright pillar 112, but not limited thereto. In some other embodiments, these assembly holes 112B can be orderly arranged on at least two or three surfaces of the tubular column body 112A of the first upright pillar 112, according to practical conditions. In this embodiment, in the assembly direction L1, each of the assembly holes 112B is shown to have an inverted trapezoid shape. Namely, a first end F1 of the assembly hole 112B is larger than the second end F2 thereof, as shown in FIG. 1 and FIG. 2B. Thus, it is determined that the assembly direction L1 is a downward direction. Similarly, since the second upright pillar 114 is structured to be the same as the first upright pillar 112, then the second upright pillar 114 would have the tubular column body and the assembly holes, structured the same to the tubular column body 112A and the assembly hole 112B of the first upright pillar 112. As shown in FIG. 1, the assembly hole holes of the first upright pillar 112 face right at the assembly holes of the second upright pillar 114.

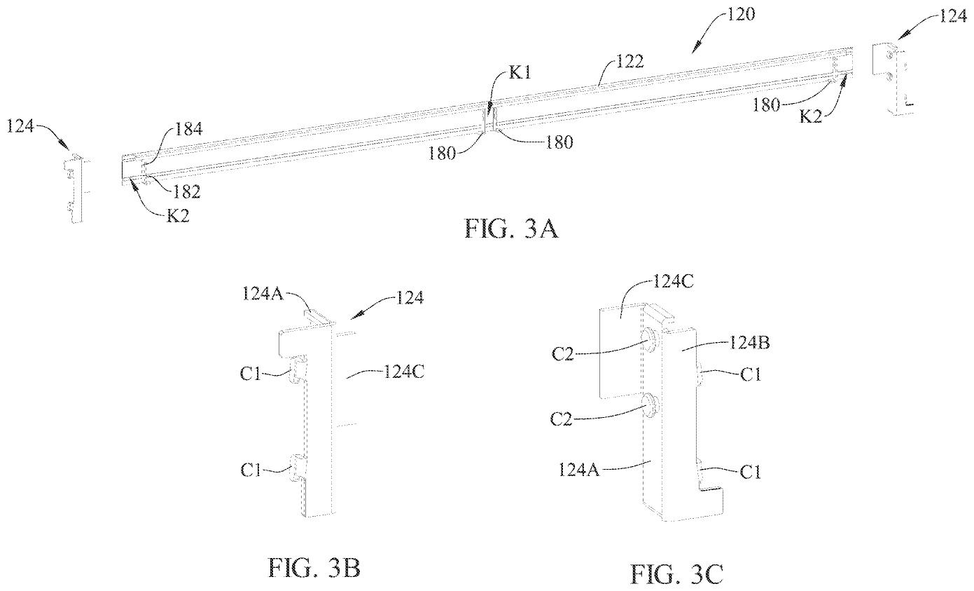

FIG. 3A is a schematic exploded view of the first horizontal constraint assembly of FIG. 1, FIG. 3B is a schematic enlarged view of the first horizontal-constraint connecting fastener of FIG. 3A, and FIG. 3C is anther view of FIG. 3B. Referring to FIG. 1, and FIG. 3A through FIG. 3C, the first horizontal constraint assembly 120 of this embodiment is disposed at the front side D1 or the rear side D2 between the two column assemblies 110. The first horizontal constraint assembly 120 includes a first horizontal constraint member 122 and two first horizontal-constraint connecting fasteners 124. In this embodiment, the two first horizontal-constraint connecting fasteners 124 are directly disposed to two opposite ends of the first horizontal constraint member 122, or connected individually to the corresponding ends of the first horizontal constraint member 122, as shown in FIG. 3A.

Preferably, the first horizontal-constraint connecting fastener 124 includes a first plate 124A, a second plate 124B, a third plate 124C, at least one horizontal-constraint phanging structure C1 and at least one rivet C2. The second plate 124B is disposed in a perpendicular manner at one side of the first plate 124A, while the third plate 124C is connected perpendicularly at another side of the first plate 124A. In particular, the third plate 124C and the second plate 124B are protruded from the first plate 124A in opposite directions. Practically, the second plate 124B can be seen as a bent plate from one side of the first plate 124A, the third plate 124C can be seen as another bent plate from another side of the first plate 124A, and the second plate 124B and the third plate 124C are bent from the first plate 124A to opposite directions.

In this embodiment, the horizontal-constraint hanging structure C1, connected to the second plate 124B, is a piece block bent from a side of the second plate 124B. The rivet C2 is disposed on the first plate 124A. In an assembly process, the first horizontal-constraint connecting fastener 124 is connected with the first horizontal constraint member 122 by having the third plate 124C to be plugged into the first horizontal constraint member 122.

In one embodiment, the combined type shelf 100 can include a plurality of engagement portions 180, and each of the engagement portions 180 can be connected to the first horizontal constraint member 122. The engagement portion 180 can include an engagement body 182 and a hanging slot 184. The hanging slot 184, penetrating through a thickness of the engagement body 182, can be used for hanging an accessory frame. Thereupon, the assembly flexibility of this disclosure can be substantially enhanced.

In this embodiment, as shown in FIG. 3A, positioning gaps K1, K2 are included in the first horizontal constraint member 122. In particularly, one of the positioning gaps K1 is formed between the two engagement portions 180 at the middle of the first horizontal constraint member 122. In addition, the positioning gap K2 is formed between the engagement portion 180 close to the respective end of the first horizontal constraint member 122 and the corresponding first horizontal-constraint connecting fastener 124. In another embodiment, the engagement portion can be formed as a “ [symbol] ” structure for providing an internal space as the aforesaid positioning gap.

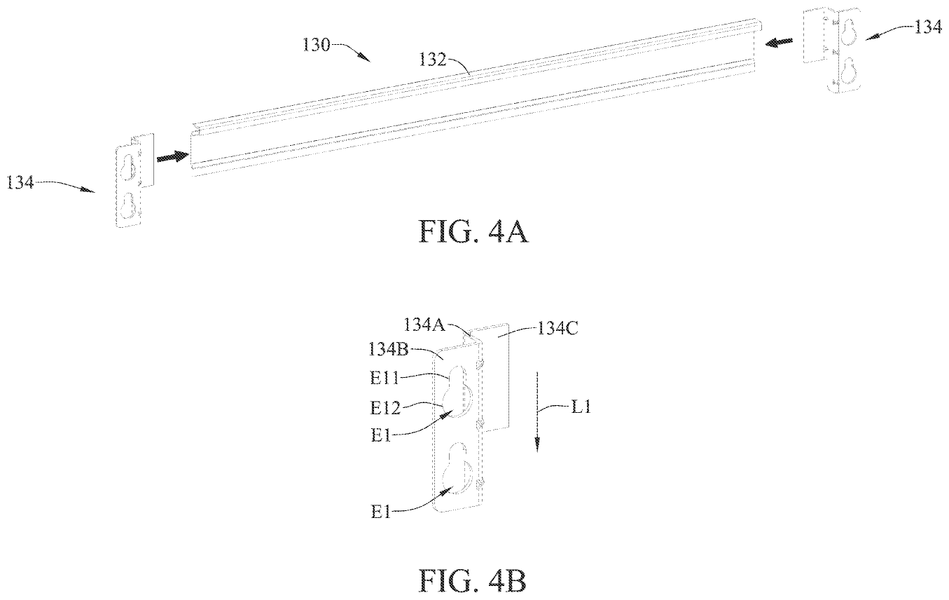

FIG. 4A is a schematic exploded view of the second horizontal constraint assembly of FIG. 1, and FIG. 4B is a schematic enlarged view of the second horizontal-constraint connecting fastener of FIG. 4A. Referring to FIG. 1, FIG. 4A and FIG. 4B, in this embodiment, the second horizontal constraint assembly 130 is located at the right-hand side D3 or the left-hand side D4 between the two column assemblies 110. Practically, the second horizontal constraint assembly 130 includes a second horizontal constraint member 132 and two second horizontal-constraint connecting fasteners 134. Each of the second horizontal-constraint connecting fasteners 134 includes at least one horizontal-constraint hole E1. In one embodiment, the second horizontal-constraint connecting fastener 134 can be directly formed at each end of the second horizontal constraint member 132. The second horizontal-constraint connecting fastener 134 is furnished with at least one horizontal-constraint hole E1. Alternatively, as shown in FIG. 4A, the two second horizontal-constraint connecting fasteners 134 can be separate components to connect the opposite ends of the second horizontal constraint member 132.

Preferably, the second horizontal-constraint connecting fastener 134 can include a first plate 134A, a second plate 134B and a third plate 134C. The second plate 134B is perpendicularly connected to one side of the first plate 134A, the third plate 134C is perpendicularly connected to another side of the first plate 134A, and the third plate 134C and the second plate 134B are extended from the first plate 134A to opposite directions. Of course, the second plate 134B can be seen as a bent from the first plate 134A, while the third plate 134C is another bent extending to a direction opposite to the second plate 134B. In an assembly process, with the third plate 134C to plug the second horizontal constraint member 132, the second horizontal-constraint connecting fastener 134 can engage the second horizontal constraint member 132 as a single piece.

In this embodiment, the horizontal-constraint hole E1, penetrating through a thickness of the second plate 134B, is extended in the assembly direction L1 by having an initial bigger hole and a narrower end slot, as shown in FIG. 4B. In particular, the horizontal-constraint hole E1 includes a first hole E11 and a second hole E12 connected spatially with the first hole E11, and the first hole E11 provides a larger empty space than the second hole E1 does.

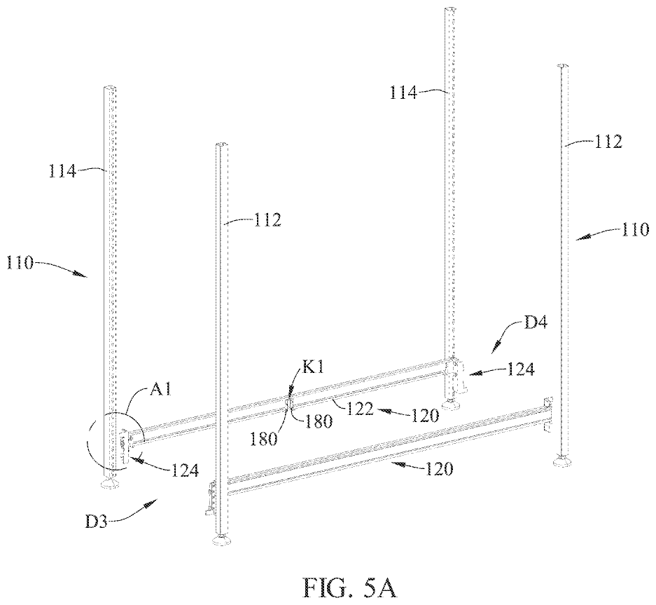

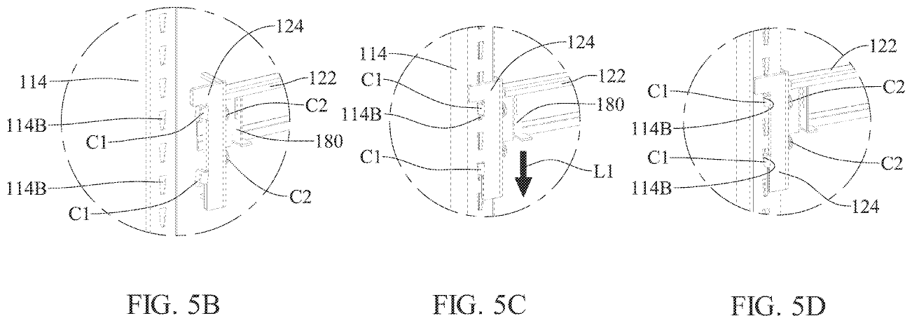

After the column assembly 110, the first horizontal constraint assembly 120 and the second horizontal constraint assembly 130 have been elucidated, then refer to FIG. 1, and FIG. 5A through FIG. 5D for explaining how the first horizontal constraint assembly 120 can be assembled to the front side D1 or the rear side D2 of the column assembly 110. In this embodiment, two first horizontal constraint assemblies 120 are moved respectively close to the corresponding front side D1 and rear side D2 of the column assembly 110. Then, as shown in FIG. 5C and FIG. 5D, the horizontal-constraint hanging structures C1 are lowered in an assembly direction L1 to engage the respective assembly holes 114B, such that the first horizontal constraint assembly 120 can connect with the rear side D2 of the corresponding column assembly 110 Similarly, the horizontal-constraint hanging structures C1 can be also lowered in the assembly direction L1 to engage the respective assembly holes 112B, such that the first horizontal constraint assembly 120 can connect with the front side D1 of the corresponding column assembly 110. As such, according to this disclosure, the first horizontal constraint assemblies 120 can be mounted fixedly to the front side D1 and the rear side D2 of the combined type shelf 100 by engaging the assembly holes 112B, 114B of the column assembly 110.

Further, in the assembly direction L1, since each of the assembly holes 112B, 114B is formed as an inverted trapezoid shape to provide a taper empty sliding space, thus a tightening function can be provided thereby while the horizontal-constraint hanging structures C1 are assembled to the corresponding assembly holes 112B, 114B.

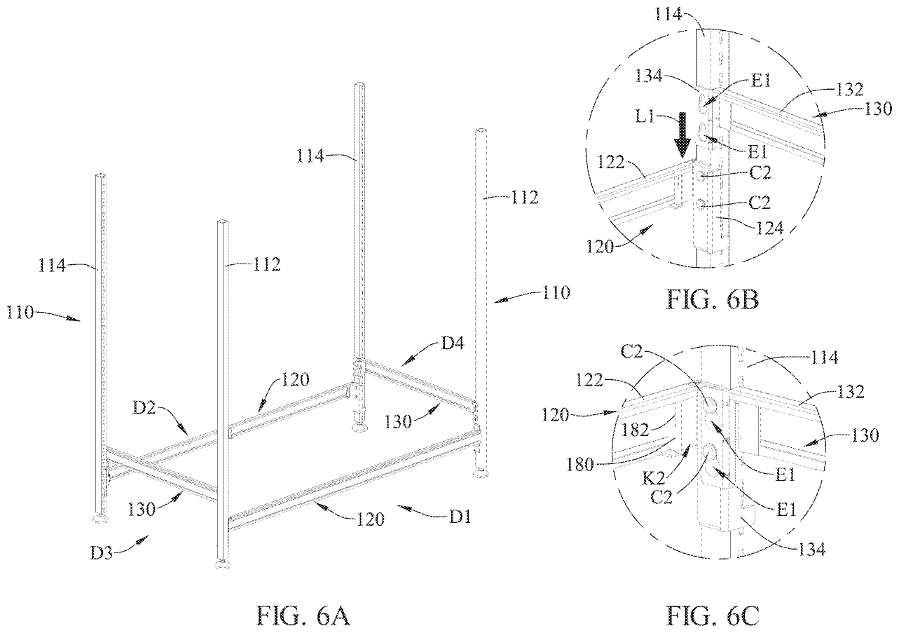

Then, referring to FIG. 1, and FIG. 6A through FIG. 6C, the process how the second horizontal constraint assemblies 130 can be mounted to the column assemblies 110 at the right-hand side D3 and the left-hand side D4 will be explained as follows. In this embodiment, the two second horizontal constraint assemblies 130 are moved close to the corresponding column assemblies 110 at the right-hand side D3 and the left-hand side D4. Then, as shown in FIG. 6B and FIG. 6C, each of the horizontal-constraint holes E1 is lowered in the assembly direction L1 to engage the corresponding rivet C2, and thus the second horizontal constraint assembly 130 can connect the corresponding column assembly 110 at the right-hand side D3 or the left-hand side D4. As such, the rivet C2 of the first horizontal constraint assembly 120 can engage the corresponding horizontal-constraint hole E1 of the second horizontal constraint assembly 130 so as to build the combined type shelf 100 fixedly at the right-hand side D3 and the left-hand side D4 thereof.

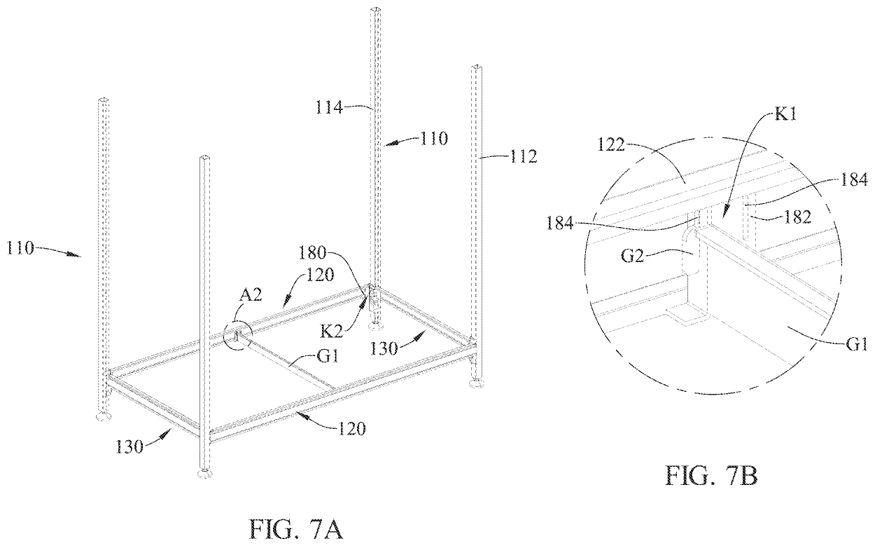

FIG. 7A demonstrates schematically an exemplary example of FIG. 6A furnished with an accessory frame connecting the two first horizontal constraint assemblies, and FIG. 7B is an enlarged view of area A2 of FIG. 7A. Referring to FIG. 1, FIG. 3A, FIG. 7A and FIG. 7B, the combined type shelf 100 further includes an accessory frame G1 having a plurality of hanging protrusions G2, as shown in FIG. 3A or FIG. 7B. The engagement portion 180 includes a hanging slot 184 for engaging the corresponding hanging protrusion G2 so as to hang therewith the accessory frame G1. With the accessory frame G1, the entire flexibility of the combined type shelf 100 provided by this disclosure can be substantially increased. In this disclosure, the accessory frame G1 can be a sliding groove structure, a sliding rack structure or a drawer rack for mounting versatile accessories such as the wire basket Ml, the drawers M2, M3, the swing door M4 of FIG. 1. Namely, this disclosure does not limit the application pattern of the accessory frame G1 to any specific type. Practically, any accessory frame G1 that can provide a hanging protrusion G2 would be qualified within the scope of this disclosure.

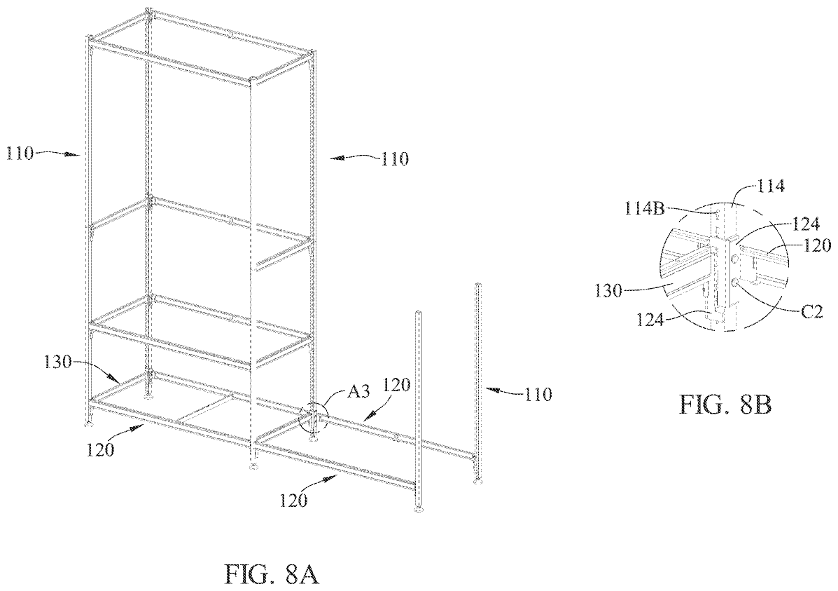

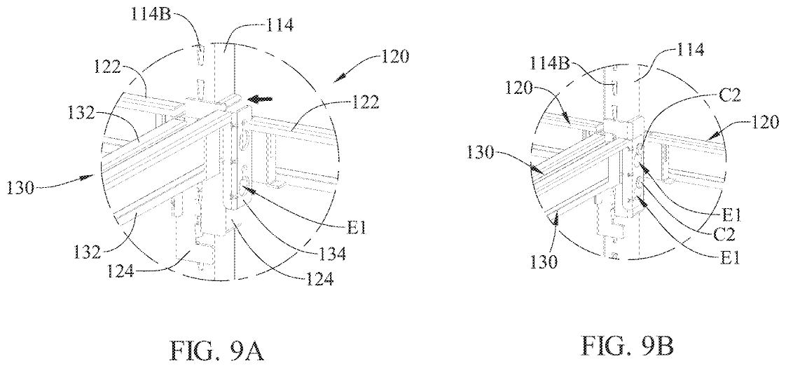

FIG. 8A demonstrates schematically another assembly process of the combined type shelf to provide a horizontal extension, and FIG. 8B is an enlarged view of area A3 of FIG. 8A. Referring to FIG. 8A and FIG. 8B, two more first horizontal constraint assemblies 120 are applied to connect an additional column assembly 110. In FIG. 8A, the free assembly holes 112B, 114B at the middle column assembly 110 (see FIG. 6B, FIG. 6C, FIG. 9A and FIG. 9B) can be utilized now to mount the two additional first horizontal constraint assemblies 120. As shown in FIG. 9A and FIG. 9B, the horizontal-constraint hole E1 of the second horizontal constraint assembly 130 can engage the corresponding rivet C2 of the additional first horizontal constraint assembly 120, such that the second horizontal constraint assembly 130 can be assembled to the lateral side of the combined type shelf 100.

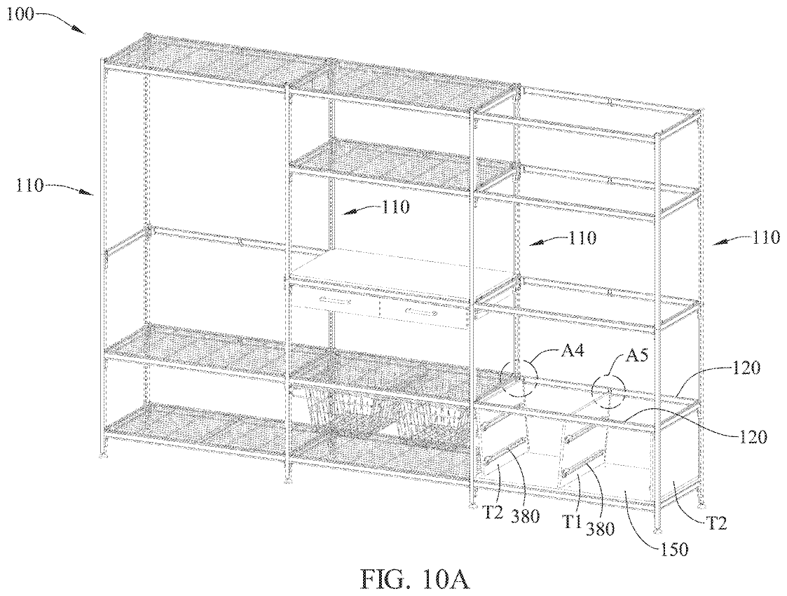

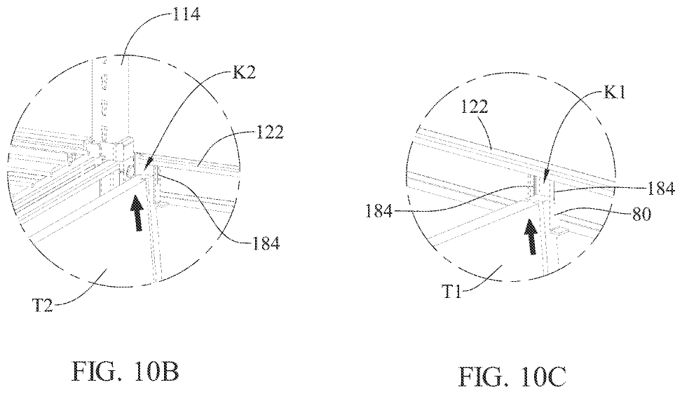

FIG. 10A shows schematically the assembly of partition plates to the combined type shelf of FIG. 1, FIG. 10B is an enlarged view of area A4 of FIG. 10A, and FIG. 10C is an enlarged view of area A5 of FIG. 10A. Referring to FIG. 1, FIG. 3A, and FIG. 10A through FIG. 10C, in this embodiment, positioning gaps K1, K2, provided to the first horizontal constraint member 122, are used for holding and positioning the partition plates T1, T2 on the corresponding storage layer such as the second storage layer 150. In this embodiment, the partition plate T1 and the partition plates T2 are partition plates trimmed to fit different mounting sites. By having FIG. 10A as an example, all the partition plate T1 and the two partition plates T2 stand upright on the second storage layer 140, in which the partition plate T1 is located between the two partition plates T2 by a distance separate from each other. Thereupon, the lower left-hand side of the combined type shelf 100 in the figure would provide two cabinet structures. In particular, the partition plate T1 and the partition plate T2 can be furnished with respective drawer racks 380. In some other embodiments, the partition plates T1, T2 might be provided with specific parts other than the drawer rack 380, but according to practical requirements.

Specifically, as shown in FIG. 3A, FIG. 10B and FIG. 10C, the positioning gaps K1, K2, the partition plate T1 and the partition plates T2 can be fit into the corresponding positioning gaps K1, K2 in an oblique manner, such that the partition plates T1, T2 can be promptly positioned. By providing the positioning gaps K1, K2 to hold the partition plates T1, T2 in position, the drawer unit B1 of FIG. 1 can be thus formed. In some other embodiments, the partition plates T1, T2 can be also used to form a swing-door cabinet B2 or a cube storage unit B3. Namely, by providing the positioning gaps K1, K2 of this disclosure, no additional fixing means is required for assembling the drawer unit B1, the swing-door cabinet B2 or the cube storage unit B3. Thereupon, the object of saving time and labor can be obtained.

In addition, as shown in FIG. 10C, the engagement portion 80 can include an engagement body 182 and a hanging slot 184, in which the hanging slot 184 penetrates through a thickness of the engagement body 182. In particular, the engagement portion 80 of FIG. 10C can be exactly the engagement portion 180 of FIG. 3A. Thus, with the hanging slot 184 of the engagement portion 80 at the first horizontal constraint assembly 120, various accessory frames such as the sliding groove structure, the drawer rack and the sliding rack structure can be mounted thereto. However, it shall be understood that the aforesaid embodiments and the associated drawings are not listed to limit the application of this disclosure. Practically, according to different requirements, different combinations of the sliding groove structure, the drawer rack and the sliding rack structure can be built to the combined type shelf of this disclosure.

In summary, the combined type shelf provided in this disclosure needs no tools for assembly. With the assembly holes of the column assembly, the first horizontal constraint assembly and the second horizontal constraint assembly can be easily mounted to form the combined type shelf of this disclosure, the horizontal extension of the combined type shelf is then much easier, and also the entire assembly flexibility can be kept high.

Further, since the first horizontal constraint assembly of this disclosure is provided with the hanging function, thus the accessory frame can be arbitrarily added into the combined type shelf, and so the entire flexibility can be further upraised.

In addition, through the positioning gaps at the first horizontal constraint member of this disclosure, no additional locking means is required for assembling and positioning the drawer unit, the swing-door cabinet or the cube storage unit. Thereupon, the object of saving both labor and time can be achieved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A combined type shelf, comprising:
at least two column assemblies, each of the at least two column assemblies including a plurality of assembly holes;
a plurality of first horizontal constraint assemblies, each of the plurality of first horizontal constraint assemblies including a first horizontal constraint member and two first horizontal-constraint connecting fasteners, the two first horizontal-constraint connecting fasteners being connected respectively to two opposite ends of the first horizontal constraint member, each of the two first horizontal-constraint connecting fasteners including at least one horizontal-constraint hanging structure and at least one rivet, each of the at least one horizontal-constraint hanging structure being lowered in an assembly direction to engage one of the plurality of assembly holes to connect the corresponding first horizontal constraint assembly to a font side or a rear side of the respective column assembly;
a plurality of second horizontal constraint assemblies, each of the plurality of second horizontal constraint assemblies including at least one horizontal-constraint hole, each of the at least one horizontal-constraint hole being lowered in the assembly direction to engage one of the at least one rivet to connect the corresponding second horizontal constraint assembly to a left-hand side or a right-hand side of the respective column assembly; and
a plurality of storage layers, disposed between two of the at least two column assemblies, each of the plurality of first horizontal constraint assemblies and each of the plurality of second horizontal constraint assemblies being used to support one of the plurality of storage layers.

2. The combined type shelf of claim 1, further including a plurality of engagement portions, each of the plurality of engagement portions connecting the first horizontal constraint member, each of the plurality of engagement portions including a hanging slot.

3. The combined type shelf of claim 2, further including an accessory frame, the accessory flame including a plurality of hanging protrusions, each of the plurality of hanging protrusions being engaged with the corresponding hanging slot of the respective engagement portion.

4. The combined type shelf of claim 2, further including a plurality of positioning gaps disposed at the first horizontal constraint member, wherein each of the plurality of positioning gaps being used for holding and positioning at least one partition plate on the storage layer.

5. The combined type shelf of claim 4, wherein the plurality of partition plates form one of a drawer unit, a swing-door cabinet and a cube storage unit.

6. The combined type shelf of claim 1, wherein each of the horizontal-constraint holes is extended in the assembly direction by having an initial bigger hole and a narrower end slot.

7. The combined type shelf of claim 1, wherein each of the column assemblies includes a first upright pillar and a second upright pillar, at least one surface of the first upright pillar is furnished orderly with the assembly holes, at least another one surface of the second upright pillar is furnished orderly with the assembly holes, and each of the assembly holes on the first upright pillar and the second upright pillar is extended in the assembly direction into an inverted trapezoid shape.
